(19) United States
(12) Patent Application Publication
(10) Pub. No.: US 2005/0203921 A1
(43) Pub. Date: Sep. 15, 2005

(54) System for protecting database applications from unauthorized activity

(76) Inventors: Aaron Charles Newman, New York, NY (US); Emiliano Berenbaum, New York, NY (US)

Correspondence Address: Peter S. Canelias;Law Offices of Peter S. Canelias, Suite 2148, 420 Lexington Avenue, New York, NY, 10170, US

(21) Appl. No.: 10/798,079

(22) Filed: Mar. 11, 2004

(51) Int. Cl. G06F 7/00

(52) U.S. Cl. 707/100

(57) ABSTRACT

A method for protecting database applications including analyzing the activity on the server, analyzing the response from the server, and blocking malicious or unauthorized activity. Commands are analyzed for suspicious or malicious SQL statements or access to unauthorized data. Server responses are monitored for suspicious results likely to have occurred from a successful attack or unauthorized access to data. When malicious or unauthorized activity occurs, activity by the source is blocked or an alert is issued.

### BACKGROUND OF THE INVENTION

The present invention relates generally to a method and system for detecting and preventing attacks in a database application, particularly, the invention relates to detecting and blocking unwanted or unauthorized intrusion attempts into database applications at the session or application level by monitoring for and protecting against malicious and anomalous commands. As well, the invention provides for a method of auditing and recording activity on a database for historical and forensic purposes.

In order to protect networks, network and host-based intrusion detection/prevention devices exist. These network and host-based intrusion detection/protection tools provide security management capabilities for network host computers or servers. One example of such a system is described in U.S. Pat. No. 6,647,400, issued Nov. 11, 2003 to Moran for an invention titled System and Method for Analyzing Filesystems to Detect Intrusions. Other examples are described in U.S. Pat. No. 6,405,318, issued Jun. 11, 2002 to Rowland for an invention titled Intrusion Detection System; U.S. Pat. No. 6,363,489, issued Mar. 26, 2002 to Comay et al. for an invention titled Method for Automatic Intrusion Detection and Deflection in a Network; and U.S. Pat. No. 6,279,113, issued Aug. 21, 2001 to Vaidya for an invention titled Dynamic Signature Inspection-Based Network Intrusion Detection.

Intrusion detection/prevention systems described above monitor for attacks at the network level. They monitor for attacks embedded within packets. Because they monitor for attacks at the packet level, they can not access session data contained with the context of the packet. In other words, these intrusion detection engines are focused on attacks contained with the Transmission Control Protocol/Internet Protocol (“TCP/IP”) headers of the packet or other simplistic attacks at the network level. They do nothing to understand the complex protocols of the database application they are monitoring. This results in attacks being able to bypass detection by being hidden inside the application session.

As well, these existing systems monitor activity as it enters a network. The goal of the invention described herein is to prevent security monitoring and protection from being circumvented by finding alternate methods of entering a network, particularly one which is not monitored by one of the aforementioned systems. The invention exists at the target of the attack, residing alongside the database application, and provides a reliable method of monitoring and preventing attacks against the database applications, even if the attack is enabled deep into a Structured Query Language (“SQL”) command.

Organizations have traditional monitored their networks at the perimeter using network-based Intrusion Detection System (“IDS”) engines to catch attacks. Unfortunately, in an ever-changing world, perimeter security has failed to provide adequate security. Modern networks are too complex to expect perimeter security to hold up. And, as users are frequently required to open up their networks to business partners, employees, and customers, varied and often unsupervised access to the network itself makes perimeter security obsolete.

There are other factors as well that lead to the crumbling of perimeter security. Wireless access points have made networks hard to protect at the perimeter. Finally, the biggest problem is that the majority of attacks are launched from insiders—people that have the means to effect authorized access to the network. This includes disgruntled employees, curious users, and administrators. If the gravest threats are inside the local network already, monitoring for attacks from outside is ineffective.

The present invention solves these problems by protecting information at the source. By locking data where it sits, the invention provides the most cost effective security. The database is where the most valuable information is stored, and protecting the data at the database level is the superior way to detect and prevent security breaches.

### BRIEF SUMMARY OF THE INVENTION

The invention is a security solution designed to monitor and detect malicious activity against a database. The invention operates at the application level monitoring for a wide variety of attacks ranging from scripted password attacks to buffer overflows to malicious SQL statements. The invention monitors for real-world attacks where it counts most—at the source.

The invention is a real time, active monitoring and prevention system and the method including a rules-based detection engine and a pattern-learning engine. The rules-based detection engine is implemented as a system that hooks into the database to poll the protocol traffic. The agent normalizes the database activity and feeds it to a rule engine. The rule engine will pass the normalized traffic through a decision tree composed of different “rule” nodes. The loaded set of rules is known as a policy. The policy is a dynamic list of the rules and is stored persistently in an XML file. A policy dictates which rules are checked against the events from the database application.

In a preferred embodiment, the invention may be implemented as either a software or hardware process. The invention has many features to help monitor the database applications. These include:
The ability to monitor databases at the source for malicious activity at the application level.
A sophisticated notification system which can send alerts to an existing monitoring infrastructure or to the invention itself. Alerts can be sent out using a variety of mechanisms including Simple Network Management Protocol (“SNMP”) and electronic or e-mail. Alerts can also be written to a local file on disk.
An intuitive web-based interface that allows for easy configuration and monitoring of agents.
A scalable architecture that allows a single console to monitor thousands of databases.
A little-weight agent designed to have negligible impact on the performance or functionality of a database.
An extensive and continuously updated library of attack signatures that reflects real-world attacks.

### BRIEF DESCRIPTION OF THE DRAWINGS

The above-mentioned and other features and objects of this invention and the manner of obtaining them will become apparent and the invention itself will be better understood by reference to the following description taken in conjunction with the accompanying drawings, wherein:

FIG. 1 is a schematic of a preferred embodiment of the invention;

FIG. 2 is a schematic of a preferred embodiment of the invention with two subnets;

FIG. 3 is a schematic of a preferred embodiment of a dispatcher of the present invention;

FIG. 4 is a block diagram showing the operation of a preferred embodiment of the present invention.

### DETAILED DESCRIPTION

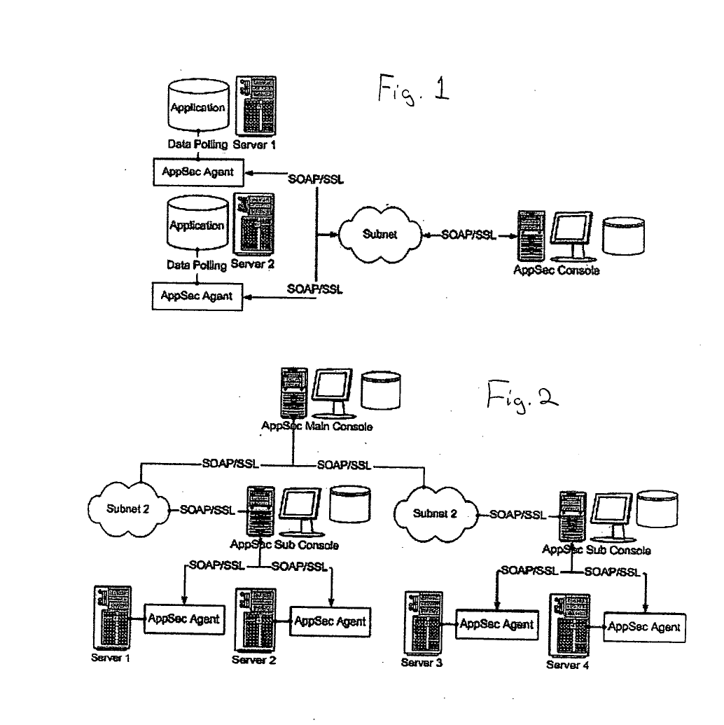

The invention consists of three components—an agent, a console, and a browser. FIG. 1 shows two AppSec Agents and an AppSec Console. The browser represents the presentation aspect of the invention. The browser is not included in the application, yet is used by the user of the invention to connect to and use the console. The browser is actually a device to view the resulting data present as HyperText Markup Language (“HTML”) and eXtensible Markup Language (“XML”) from the console. Both the agent and the console are components included with the invention.

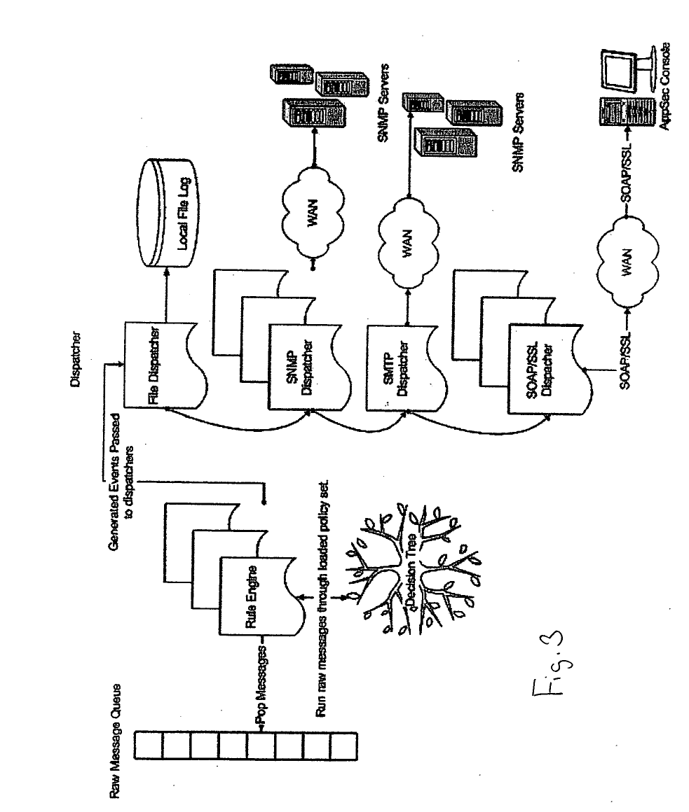

The console is installed on a shared, network-accessible hardware component. The console is composed of a web application used to configure and monitor the activity of one or more agents. The console listens on a Transmission Control Protocol (“TCP”) port for requests from browsers. As well, the console listens for connections from the agents for security alerts. The console will store and archive security events coming from agents. The console serves as the repository for configuration and security alert data. As shown in FIG. 2, a sub console may be used in a more complex application of the invention.

The agent is installed on each database application for which it is to monitor and protect. The agent is a light-weight process that hooks into the database to received events. The agent analyzes these events and detects/prevents any malicious activity. All malicious activities is recorded, processed, and forwarded to the console.

The browser is used to connect to the console. The browser can be any standard HTTP browser including Internet Explorer or Netscape Navigator. The browser can be run on any workstation for which TCP/IP connectivity exists. The browser is intended to be a light-weight tool designed for presenting the data from the console.

The interaction between the browser and console is as follows:
Step 1, the administrator or user of the system starts up a browser and enters the IP address and port of the console;
Step 2, the console responds by asking the user for authentication credentials;
Step 3, the user of the system provides credentials for the system;
Step 4a, if the credentials provided by the system are valid, the privileges and permissions for the user are loaded into the user's session, and the process proceeds to Step 5;
Step 4b, if the credentials provided to the system are not valid, an error message is returned to the user notifying them that the credentials are not valid, and the process returns to Step 1;
Step 5, if the user has administrator privileges on the console, the user is allowed to navigate to the system configuration screens;
Step 6, if the user does not have administrator privileges on the console, the user is only allowed to access the monitoring component of the console.

The console setup installs the web-based application that will be used to manage and receive alerts from the agents. If the console is to be used for collecting alerts from agents, the console should be installed on a dedicated server. If the console will be used only to manage the agents, the console will not need to be running constantly and can be installed on an administrator's workstation.

The agent setup is used to install the agent on each machine hosting the database to be monitored. To install the agent, the user must log into the machine to be monitored and run the installation program.

There are a variety of communications between the agent and the console. The initial communication occurs when an agent is registering itself with the console. The communication is as follows:
Step 1, the user begins installing the agent on the database application;
Step 2, the user enters the IP address, port, and credentials for the console;
Step 3, the installation process connects to the console using the credentials provided;
Step 4, the console responds with an error message if the wrong credentials were provided, and the process returns to Step 2;
Step 5, the console responds with a successful message if valid credentials are provided;
Step 6, the installation process creates an RSA public/private key and a certificate request;
Step 7, the installation process sends the certificate request to the console;
Step 8, the console uses the certificate request to create a certificate and signs the certificate with its own private key;
Step 9, the console sends the certificate back to the client;
Step 10, the install program accepts the certificate from the console and persists the certificate to the disk;
Step 11, the install program tears down the current connection;
Step 12, the install program opens a new mutually-authenticated Secure Socket Layer (“SSL”) connection with the console;
Step 13, the install program sends a confirmation message to register the agent with the console;
Step 14, the console persists to disk the information on the agent and sets up to accept security alerts from the agent;

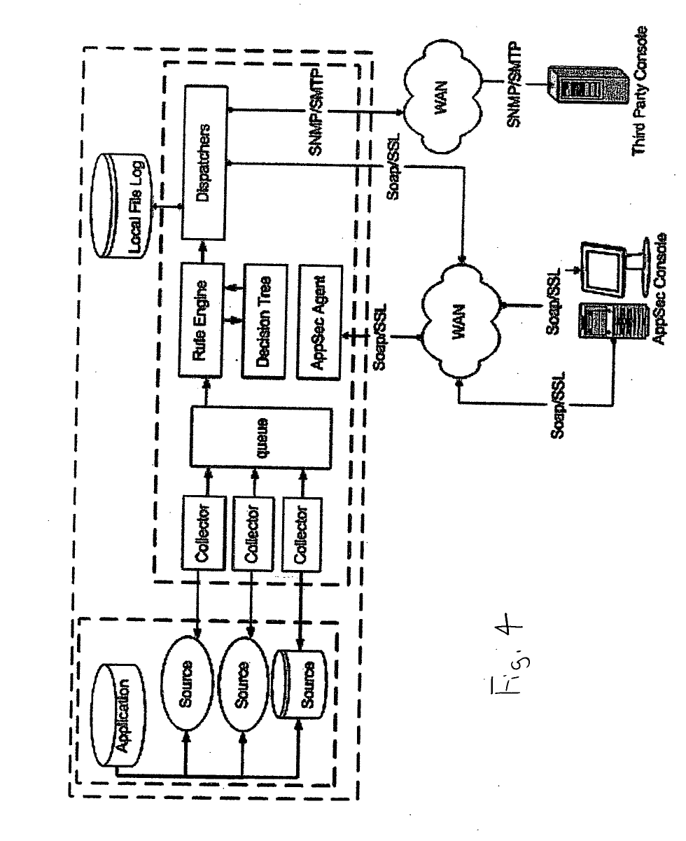

As shown in FIG. 3, the agent creates a decision tree from the policy and rules files in its configuration. The decision tree is used by the rule engine to process all normalized traffic. The normalized traffic is generated by the polled sources as shown in FIG. 4. The application “collectors” poll different data sources for traffic (event list, log files and built-in profile sources). The rule engine takes raw messages from the different collectors and amalgamates the data from different sources into a unified message stream which is fed into the decision tree.

The decision tree can be trained by an operator via a set of exceptions. Exceptions are translated into rule filters. The corresponding rule node in the decision tree will be replaced with the generated rule exception node. This process can be used by the operator to fine-tune the decision tree for the particular agent deployment.

The size and depth of the decision tree is controlled by the number of rules loaded via the policy configuration. The policy dictates what rules the agent will use against the raw message stream. Rules are then translated directly into nodes in the decision tree.

When an agent is started, all collectors for the agent are attached to the configured data sources as shown in FIG. 4. Collectors are responsible for polling all the traffic on the application. Each atomic or particulate piece of traffic is normalized and mapped into a message. The message is used by the rule engine to determine the type of attack or event.

The following system events are detected by the agent:
Agent registered
Agent unregistered
Agent started
Agent stopped
Database stopped
Database started
Database crashed

Each of these system events should be a standard rule with a type of “System Event”. The “default policy”, which may or may not contain these events, will be pulled to an agent when it is first installed. These system rules can be enabled and disabled just like any other rules. The rules enabled in the policy dictate what alerts are generated—if the policy has the system events database shutdown and startup as events to alert on, alerts will be generated for the agent when the event occurs.

A particular event in the database might create a large number of distinct and separate atomic events on the different data sources. The collectors can chain the different messages together and create a message chain. The message chain is passed on to the rule engine.

Normalized messages are placed in a queue by the collectors. The raw message queue (FIG. 3) takes the messages from the configured collectors. The rule engine has a thread pool that will retrieve each raw message. The rule engine will determine if messages from different data sources must be amalgamated together. After the rule engine massages the normalized data, it is processed by the loaded decision tree.

The decision tree (forest) of rule nodes filters out messages stream. The top level nodes are the most general ones. The lower nodes are the more specific checks (also the most expensive checks to run). Normalized messages descend through the decision tree from very general rules to the most specific ones. This method allows the invention to prune the message traffic quickly and allows the rule engine to identify attacks accurately and quickly.

The system supports different kinds of rules that can be chained together to created more complex rule nodes. The basic rule nodes available are the Boolean AND, OR, NOT, and IF-ELSE. Other rule nodes available are EQUAL, NOT EQUAL, GREATER THAN, LESS THAN, regular expression nodes, and quick pattern matching algorithms (Boyer-Moore-Horspool).

If a rule fires, it will run its associated action. An action can generate an event, which is then passed on to the event stream. An action can be an alert or prevention. Prevention is a command run by the agent on the monitored system that will try to protect the system from the detected malicious activity.

For stream implementation of the pipes and filter patterns, in a stream each step is completed and the data (event) is handed off to the next step for continuation. Steps can be multithreaded in order to increase throughput if the data lends itself to parallel processing. This allows the invention to monitor multiple databases on the same machine. The invention can selectively indicate which instance to monitor. During the install and or configuration, the invention can update databases that the agent is monitoring or protecting.

A collector can be instantiated to poll multiple database instances. There are distinct and separate collector definitions for each database instances. Each instance will have its own distinct and separate data source. The collector instantiates itself for each distinct and unique data source.

For passing security events to third-party applications, the invention is designed to interact with third-party monitoring systems, such as HP Openview and CA Unicenter. This integration is performed using the Simple Network Management Protocol (SNMP). SNMP specifies a User Datagram Protocol (“UDP”) packet type called a Trap. A Trap is an exception to program execution that enables the program to recover from an unanticipated or unusual situation. A SNMP Trap consists of sending packets to UDP port 162. By sending out alerts via SNMP Traps, alerts can be sent to management consoles that are already in use.

The invention also contains a set of Management Information Bases (MIBs). This set of MIBs is incorporated into third-party applications to map the alert to an actual text message.

The invention uses several dispatchers each using a pipe and filters framework pattern. A pipe causes the operating system to send the output of one command to another command rather than display the result. A filter is a software feature that functions automatically to screen data. The SMTP dispatcher can send emails to a list of configured address. The file dispatcher logs all events to a file on the local disk. The file dispatcher can be configured to use file roll over in order to keep a long history of detected events. The SNMP dispatcher sends a corresponding SNMP trap to all configured targets. The console can listen for SNMP traps coming from each agent. The Simple Object Access Protocol (SOAP), which can be thought of as “XML-RPC”, is a way for a program running in one kind of operating system to communicate with a program in the same or a different kind of operating system by using the Internet's HTTP and XML as the mechanisms for information exchange. The SOAP dispatcher sends events to a target SOAP server. The console sets up a peer-to-peer relationship with the agent. The agent will communicate events back to the console via a SOAP/SSL connection.

Security alerts can be managed and monitored through the console. This is configured when setting up an agent. The agent sends the message to the console through a dispatcher. There are two forms of dispatchers that exist for forwarding the alerts from the agent to the console.

The first form of dispatcher is a SNMP Trap dispatcher. Alerts sent out through this interface result in UDP packets sent to the console over port 162. The console implements an SNMP Trap receiver which accepts SNMP traps from the agents. The console then persists these alerts into a data store.

The second form of dispatcher is a messaging queue. A messaging queue, implemented as a persistent SOAP connection that sends a chunk of data encapsulated in a SSL V3 packet over TCP/IP. A message queue provides a reliable and secure method of communication. Alerts sent out through this interface result in UDP packets sent to the console over port 162. The console implements a SOAP receiver that accepts messages from the agents. The console then persists these alerts into a data store. This sets up a peer-to peer communication channel between the console and agent.

The security alerts are viewed through a browser by a user of the invention. The alerts are persisted in the data store in several different states. When they are initially received, they are placed in an unacknowledged state in the main queue. Once the alert is view and marked as acknowledged by the user, the state is updated to “Acknowledged” in the data store. The alert can also be archived which moves the alert into a secondary data store. From the secondary data store, the alert can be exported to a text file. Finally the alert can be purged from the secondary data store which deletes the record from the data store.

The console is also designed to filter, search, and order the alerts that are persisted. The filter options work by setting a criteria for which the data must match. The criteria can consist of one or more data name/value pairs. The console appends the parameter name and value to the command used to list the alerts thereby causing only the records meeting the criteria to be used. To order the security alerts, an additional clause is placed on the command which specifies the column to order on as well as whether to order descending or ascending.

For developing custom rules, a differentiating factor in the invention is the flexibility for which rules can be written. Given an arbitrary application, containing arbitrary data with varying sensitivity levels, the ability to efficiently and effectively develop rules that in essence define the sensitive information in the application is critical. The invention consists of a component for creating rules and a component for reading rules.

Creating rules is accomplished in the console using XML parsing technology. An XML file is opened and read into memory. Each rule is represented as an XML node. When creating a new rule, a rule node is instantiated and the attributes of the nodes are set. Each attribute represents information about the events to monitor for including the event type, name, number of events, time of events, and the procedural commands associated with the events. The new XML node is then persisted back to the rule file.

“Simple” rules involve looking at a single attribute of an event. Simple rules are not often useful since they do not provide a high level of intelligence for detecting malicious activity. Several of the system events and some of the basic attacks are based on simple rules. Simple rules are however very important as building blocks for the next set of rules.

Many rules involved multiple attributes and operate based on logical and procedural relationships to other events. For example, an event may be determined to be an attack only if one attribute matches a value and another attribute specifically does not match a different value. These types of relationships are implemented as multiple XML nodes. In the case of these “complex” rules, a parent node is created to represent the logical rule. Children are defined, or may be reused from another rule, which represent one of more specific criteria. Each child is a single node. Children may have children as well, creating a complex hierarchy of nodes defining the criteria an event must match to cause a rule to fire. When the rule fires it becomes a security alert.

A further progression in the ideas of rules is the use of multiple events. Multiple events allow rules to track state and reach back into previously executed events in order to determine session state and retrieve attributes from recent events. Multiple events can evaluate to an alert differently based on the context. For instance, an attempt to retrieve sensitive information resulting from a successful password brute-force intrusion can be realized as an attack and can be blocked.

Multiple events require maintaining a cache of important event information, understanding when the data is stale and knowing when to reuse the cache. Cache is aged using a first-in-first-out (“FIFO”) algorithm. When a new item is received, the item is copied over the old item in the cache.

The rule definitions will be parsed by an XML parser and translated into rule nodes in the decision tree. The decision tree can be trained by exceptions that are created by an operator. Exceptions are translated into new filter rule nodes that replace the current existing corresponding rule nodes. The decision tree can use these new exceptions in order to provide more accurate and relevant events back to the operator.

In operation, the system may accomplish its purpose in a variety of ways, each directed to detecting forms of unauthorized or malicious activity directed at a database. The following methods of operation may be employed individually or in cooperation with each other.

In one embodiment, the system detects attempted intrusions in a database application by monitoring for an SQL statement that is executable or executed in the database application and intended to exploit a vulnerability in the protected database application. The system actuates each SQL statement to discover distinct atomic SQL commands, and analyses the atomic SQL commands against the pre-defined set of detection rules. This method is effective for protecting against attacks on database application vulnerabilities such as buffer overflows in SQL procedures or in calls from SQL to the operating system function. As used herein, SQL procedures include SQL functions.

Other protected vulnerabilities include attempts to escalate privileges of a user in the database application itself or within an operating system, and attempts to insert an invasive SQL statement into the parameters of stored procedures.

In another embodiment, the system detects anomalous command in a database application by actuating the database application in order to discover forms of sets of authorized SQL statements and commands and to discover appropriate parameters for the authorized SQL statements and commands. After actuating the database application, the system generates a rule set of the discovered forms and monitors for SQL statements executable or executed in the database application which do not match the generated rule set of forms of authorized SQL statements. The anomalous commands to be detected include SELECT, UPDATE, INSERT and DELETE statements, calls to stored procedures, and batch scripts.

Another embodiment of the present system detects attempts to access the database application from invalid sources, by actuating the database application in order to discover a normal set of authorized SQL sources, generating a rule set of characteristics of connecting at least one of the normal set of SQL sources and monitoring for SQL statements executable or executed in the database application which do not match the generated rule set of valid forms for authorized SQL statements. As used herein, the term “accessing” the database application includes without limitation such activities as reading, writing or deleting data. Examples of characteristics of the rule set are those based on the location of an SQL source, on a network address of the SQL source, on a host name of an SQL source, or the domain name of an SQL source. The characteristic of the rule set may also be based on the time of an activity by an SQL source or an application name of an SQL source, or on a behavior of an SQL source.

In another embodiment, the system detects unauthorized activity in a database application by monitoring for SQL statements executable in the database application and intended to perform activities not authorized by an SQL source. The system then actuates each discrete database event, and analyzes each event against a pre-defined set of detection rules.

This embodiment protects against unauthorized activity such as accessing data for which the SQL source has not been granted privileges, accessing data not using an authorized method, or accessing data in a data dictionary not using an authorized method. As used herein, the term “privileges” means privileges that are implicit or explicit. The unauthorized activities include interfering with auditing settings or audit records, including without limitation disabling, clearing, deleting or removing such auditing settings or audit records. Unauthorized activities also include modifying configuration settings or security settings, or using an unauthorized tool to attempt to access the database application.

In another embodiment, the system implements a method for detecting activity designed to breach security of a database application by monitoring for discrete events executable or executed in the database that are intended to breach a security mechanism associated with the database application. The system then actuates each discrete database event and analyzes the database events against a pre-defined set of detection rules.

The method is particularly effective against so called “brute-forcing,” which usually involves guessing at usernames or passwords, and sometimes generating a series of random attempts to gain access to the database. This type of attack is also employed against particular accounts within the database, either default accounts or well-known accounts within the database. Another type of attack involves scripting of password guessing against the database application.

In another embodiment, the system implements a method for detecting suspicious activity in a database application by monitoring for SQL statements executable or executed in the database application which contain characteristics indicative of an attack. The system actuates each batch statement in order to discover atomic SQL commands, and then analyzes the atomic SQL commands against a pre-defined set of rules to identify the suspicious activity. This method protects against such suspicious activities as the use of comments within an SQL statement, the use of a UNION keyword within an SQL statement, or the use of a keyword designed to suppress auditing data.

In another embodiment, the system implements a method for detecting use of keywords to suppress auditing of attacks in a database application by monitoring for SQL statements that contain a keyword, where the keyword results in audit data being suppressed. The system detects a suppressed SQL statement, and also detects the conclusion of the suppressed SQL statement, and then determines that no execution of the keyword designed to suppress said SQL statement actually occurred. This method may further include the use of passwords designed to cause an auditing system to suppress text of an SQL statement and thereby masking malicious activity.

In another embodiment, the system implements a host-based intrusion prevention method for blocking attacks on database applications by detecting an attack occurring through a session with the database application. The system identifies the source of the attack, implements a method of stopping the attack source, and also implements a method of preventing further attacks from the attack source. The method of stopping the attack source may be killing the user connection of the attack source, sending a reset to the attack source, blocking a SQL command, intercepting and filtering a SQL command, or throwing an exception. The method of preventing further attacks may be disabling an account from being used or killing any future attempts from the attack source.

In another embodiment, the system implements a method for detecting attempts to inject SQL into a database application by monitoring for SQL statements executable or executed in the database application and intended to run queries not designed to be run by a middle-tier application. The system analyzes the SQL statement's identifying characteristics that indicate SQL injection, and implements an action upon detection of identifying characteristics that indicate SQL injection. The actions may include causing a security alert to be fired or causing the SQL statement to be blocked.

In another embodiment, the system implements a method for detecting attempts to inject SQL into a database application by listening to SQL queries executable or exectued on the database application for some determined period of time, tokenizing SQL statements into standard forms, recording the combination and the order of tokens expected, and then analyzing the SQL statements received later to identify those that do not conform to the expected combination of tokens.

In another embodiment, the system implements a method for detecting malicious activity in a database application by listening to SQL queries executable or executed on the database application, analyzing SQL statements by applying regular expressions to detect vulnerabilities, and sending alerts when an SQL statement matching a regular expression is discovered. The regular expression may be designed to detect the following: (1) a buffer overflow in a call from SQL to a built-in database function; (2) a buffer overflow in a call from SQL to an operating system function; (3) an attempt to escalate privileges of a user in the database application; (4) an attempt to insert an SQL statement into a parameter of stored procedures; or (5) an attempt to escalate privileges of a user in an operating system.

In another embodiment, the system implements a method for detecting activity which may result in cross-site scripting vulnerabilities. The system monitors for SQL statements executable or executed in the database application, and actuates each batch statement in order to discover atomic SQL commands. The system then examines the atomic SQL commands for the presence of HTML tags. This method is effective against HTML tags, including unencoded HTML tags and hex encoded HTML tags.

In another embodiment, the system implements a method for monitoring all activity for security auditing. The system monitors for an event generated by a database application, actuates the event, and records the event. This method is effective against events such as those containing SQL statements, failed or successful logins, incomplete attempts to access the database application, DBA activity, changes to a configuration, enabling of application roles, granting, revoking, or denying permissions or privileges, utility events including such utility events as a backup command, a restore command, a bulk insert command, a BCP command, or a DBCC command. Other events include server shutdowns, pauses, start-ups, audit events, including add audit commands, modify audit commands, and stop audit commands, and use of extended stored procedures.

In another embodiment, the system implements a method for providing exceptions to security alerts. The system accomplishes this by monitoring for events generated by a database application, filtering alerts raised that match a defined set of rules, and passing alerts that do not match a normal definition of the predefined set of rules. The defined set of rules may include values for each field collected for each event. The filtering may be matched by comparing values of each field with values defined in an exception.

Since other modifications or changes will be apparent to those skilled in the art, there have been described above the principles of this invention in connection with specific apparatus and method steps, it is to be clearly understood that this description is made only by way of example and not as a limitation to the scope of the invention.

1. A method for detecting attempted intrusions in a database application, the method comprising:
monitoring for an SQL statement, said SQL statement executable in said database application and intended to exploit a vulnerability;
actuating said SQL statement to discover an atomic SQL command;
analyzing said atomic SQL command against a pre-defined set of detection rules.

2. The method according to claim 1, wherein said vulnerability is a buffer overflow in a SQL procedure.

3. The method according to claim 1, wherein said vulnerability is a buffer overflow in a call from SQL to an operating system function.

4. The method according to claim 1, wherein said vulnerability is an attempt to escalate privileges of a user in said database application.

5. The method according to claim 1, wherein said vulnerability is an attempt to escalate privileges within an operating system.

6. The method according to claim 1, wherein said vulnerability is an attempt to insert an invasive SQL statement into a parameter of stored procedures.

7. A method for detecting an anomalous command in a database application, the method comprising:
actuating said database application in order to discover a form of a set of authorized SQL statements and commands and to discover appropriate parameters for said statements and commands;
generating a rule set of said discovered form of said authorized SQL statements;
monitoring for SQL statements executable in said database application which do not match said generated rule set of forms of authorized SQL statements.

8. The method according to claim 7, wherein said anomalous command is a SELECT statement.

9. The method according to claim 7, wherein said anomalous command is an UPDATE statement.

10. The method according to claim 7, wherein said anomalous command is an INSERT statement.

11. The method according to claim 7, wherein said anomalous command is a DELETE statement.

12. The method according to claim 7, wherein said anomalous command is a call to a stored procedure.

13. The method according to claim 7, wherein said anomalous command is a batch script.

14. A method for detecting attempts to access a database application from invalid sources, the method comprising:
actuating said database application in order to discover a normal set of authorized SQL sources;
generating a rule set of characteristics of connecting at least one of said normal set of SQL sources;
monitoring for SQL statements executable in said database application which do not match said generated rule set of valid forms for authorized SQL statements.

15. The method according to claim 14, wherein a characteristic of said rule set is based on a location of an SQL source.

16. The method according to claim 14, wherein a characteristic of said rule set is based on a network address of an SQL source.

17. The method according to claim 14, wherein a characteristic of said rule set is based on a host name of an SQL source.

18. The method according to claim 14, wherein a characteristic of said rule set is based on a domain name of an SQL source.

19. The method according to claim 14, wherein a characteristic of said rule set is based on a time of activity of an SQL source.

20. The method according to claim 14, wherein a characteristic of said rule set is based on an application name of an SQL source.

21. The method according to claim 14, wherein a characteristic of said rule set is based on a behavior of an SQL source.

22. A method for detecting unauthorized activity in a database application, the method comprising:
monitoring for SQL statements executable in said database application and intended to perform activities not authorized by an SQL source;
actuating each discrete database event;
analyzing each event against a pre-defined set of detection rules.

23. The method according to claim 22, wherein said unauthorized activity is accessing data for which said SQL source has not been granted privileges.

24. The method according to claim 22, wherein said unauthorized activity is accessing data not using an authorized method.

25. The method according to claim 22, wherein said unauthorized activity is accessing data in a data dictionary not using an authorized method.

26. The method according to claim 22, wherein said unauthorized activity is interfering with auditing settings.

27. The method according to claim 22, wherein said unauthorized activity is interfering with audit records.

28. The method according to claim 22, wherein said unauthorized activity is modifying configuration settings.

29. The method according to claim 22, wherein said unauthorized activity is modifying security settings.

30. The method according to claim 22, wherein said unauthorized activity is a use of an unauthorized tool to attempt to access said database application.

31. A method for detecting activity designed to breach security of a database application, the method comprising:
monitoring for discrete events executable in said database application and intended to breach a security mechanism associated with said database application; actuating each discrete database event;
analyzing said database events against a pre-defined set of detection rules.

32. The method according to claim 31, wherein said activity is a brute-force guessing of usernames in said database application.

33. The method according to claim 31, wherein said activity is the brute-force guessing of usernames and passwords for default accounts in said database application.

34. The method according to claim 31, wherein said activity is the brute-force guessing of usernames and passwords for well-known accounts in said database application.

35. The method according to claim 31, wherein said activity is the scripting of password guessing against the database application.

36. A method for detecting suspicious activity in a database application, the method comprising:
monitoring for SQL statements executable in said database application which contain characteristics indicative of an attack;
actuating each batch statement in order to discover atomic SQL commands;
analyzing said atomic SQL commands against a pre-defined set of rules to identify said suspicious activity.

37. The method according to claim 36, wherein said suspicious activity is a use of comments within an SQL statement.

38. The method according to claim 36, wherein said suspicious activity is a use of a UNION keyword within an SQL statement.

39. The method according to claim 36, wherein said suspicious activity is a use of a keyword designed to suppress auditing data.

40. A method for detecting use of keywords to suppress auditing of attacks in a database application, the method comprising:
monitoring for SQL statements that contain a keyword, where said keyword results in audit data being suppressed;
detecting a suppressed SQL statement;
detecting a conclusion of said suppressed SQL statement;
determining that no execution of said keyword designed to suppress said SQL statement actually occurred.

41. The method according to claim 40, further comprising a use of passwords designed to cause an auditing system to suppress text of said SQL statement and masking malicious activity.

42. A host-based intrusion prevention method for blocking attacks on database applications, the method comprising:
detecting an attack occurring through a session with said database application;
identifying a source of said attack;
implementing a method of stopping said attack source;
implementing a method of preventing further attacks from said attack source.

43. The method according to claim 42, wherein said method of stopping said attack source is killing a user connection of said attack source.

44. The method according to claim 42, wherein said method of stopping said attack source is sending a reset to said attack source.

45. The method according to claim 42, wherein said method of stopping said attack source is blocking a SQL command.

46. The method according to claim 42, wherein said method of stopping said attack source is intercepting and filtering a SQL command.

47. The method according to claim 42, wherein said method of stopping said attack source is throwing an exception.

48. The method according to claim 42, wherein said method of preventing further attacks is disabling an account from being used.

49. The method according to claim 42, wherein said method of preventing further attacks is killing any future attempts from said attack source.

50. A method for detecting attempts to inject SQL into a database application, the method comprising:
monitoring for SQL statements executable in said database application and intended to run queries not designed to be run by a middle-tier application;
analyzing said SQL statement's identifying characteristics indicative of SQL injection;
implementing an action upon detection of identifying characteristics indicative of SQL injection.

51. The method according to claim 50, wherein said action is causing a security alert to be fired.

52. The method according to claim 50, wherein said action is causing the SQL statement to be blocked.

53. A method for detecting attempts to inject SQL into a database application, the method comprising:
listening to SQL queries executable on said database application for a determined period of time;
tokenizing SQL statements into standard forms;
recording a combination and an order of tokens expected;
analyzing SQL statements received later to identify those that do not conform to said expected combination of tokens.

54. A method for detecting malicious activity in a database application, the method comprising:
listening to SQL queries executable on said database application;
analyzing SQL statements by applying regular expressions to detect vulnerabilities;
sending alerts when an SQL statement matching a regular expression is discovered.

55. The method according to claim 54, wherein said regular expression is designed to detect a buffer overflow in a call from SQL to a built-in database function.

56. The method according to claim 54, wherein said regular expression is designed to detect a buffer overflow in a call from SQL to an operating system function.

57. The method according to claim 54, wherein said regular expression is designed to detect an attempt to escalate privileges of a user in said database application.

58. The method according to claim 54, wherein said regular expression is designed to detect an attempt to insert an SQL statement into a parameter of stored procedures.

59. The method according to claim 54, wherein said regular expression is designed to detect an attempt to escalate privileges of a user in an operating system.

60. A method for detecting activity which may result in cross-site scripting vulnerabilities, the method comprising:
monitoring for SQL statements executable in said database application;
actuating each batch statement in order to discover atomic SQL commands;
examining an atomic SQL command for HTML tags.

61. The method according to claim 60, wherein said atomic SQL command contains an HTML tag.

62. The method according to claim 61, wherein said HTML tag is unencoded.

63. The method according to claim 61, wherein said HTML tag is hex encoded.

64. A method for monitoring all activity for security auditing, the method comprising:
monitoring for an event generated by a database application;
actuating said event;
recording said event.

65. The method according to claim 64, wherein said event being generated comprises an SQL statement.

66. The method according to claim 64, wherein said event being generated comprises failed logins and successful logins.

67. The method according to claim 64, wherein said event being generated comprises incomplete attempts to access said database application.

68. The method according to claim 64, wherein said event being generated comprises DBA activity.

69. The method according to claim 64, wherein said event being generated comprises changes to a configuration.

70. The method according to claim 64, wherein said event being generated comprises enabling of application roles.

71. The method according to claim 64, wherein said event being generated comprises a method of granting, revoking, or denying permissions or privileges.

72. The method according to claim 64, wherein said event being generated comprises a utility event.

73. The method according to claim 72, wherein said utility event is a backup command.

74. The method according to claim 72, wherein said utility event is a restore command.

75. The method according to claim 72, wherein said utility event is a bulk insert command.

76. The method according to claim 72, wherein said utility event is a BCP command.

77. The method according to claim 72, wherein said utility event is a DBCC command.

78. The method according to claim 64, wherein said event being generated comprises a server shutdown.

79. The method according to claim 64, wherein said event being generated comprises a pause.

80. The method according to claim 64, wherein said event being generated comprises a start-up.

81. The method according to claim 64, wherein said event being generated comprises an audit event.

82. The method according to claim 81, wherein said audit event is an add audit command.

83. The method according to claim 81, wherein said audit event is a modify audit command.

84. The method according to claim 81, wherein said audit event is a stop audit command.

85. The method according to claim 64, wherein said event being generated comprises use of extended stored procedures.

86. A method for providing exceptions to security alerts, the method comprising:
monitoring for events generated by a database application;
filtering alerts raised that match a defined set of rules;
passing alerts not matching a normal definition of said defined set of rules.

87. The method according to claim 86, wherein said defined set of rules comprises values for each field collected for each event.

88. The method according to claim 86, wherein said filtering is matched by comparing values of each field with values defined in an exception.
